(19) United States
(12) Patent Application Publication
(10) Pub. No.: US 2015/0177743 A1
(43) Pub. Date: Jun. 25, 2015

(54) GRADIENT SOLUTION SENDING APPARATUS

(71) Applicant: Shimadzu Corporation, Kyoto-shi (JP)

(72) Inventor: Takaei Kitagawa, Kyoto (JP)

(21) Appl. No.: 14/643,135

(22) Filed: Mar. 10, 2015

Related U.S. Application Data
(62) Division of application No. 11/634,942, filed on Dec. 7, 2006.

(30) Foreign Application Priority Data
Dec. 22, 2005 (JP) 2005-370414

(51) Int. Cl. G05D 11/035; B01D 15/14; B01F 15/04

(52) U.S. Cl. CPC G05D 11/035; B01F 15/0479; B01D 15/14; B01F 2215/0036

(57) ABSTRACT

A gradient solution sending apparatus includes a plurality of solution sending flow channels, a mixer, a gradient controller in which a solution sending flow rate is set, and a control device which controls a solution sending flow rate of a mobile phase of each solution sending flow channel based on the solution sending flow rate set in the gradient controller. Each channel includes a solution sending pump and a split mechanism. The solution sending pump sends the solution of each mobile phase. The split mechanism delivers a part of the mobile phase passing through the solution sending pump, and the split mechanism discharges the rest of the mobile phase from the channel. A mixer is arranged on downstream sides of the solution sending flow channels, and the mixer mixes the mobile phases sent from the solution sending flow channels and delivers the mixed mobile phase to the analysis flow channel.

### BACKGROUND OF THE INVENTION

1. Field of the Invention

The present invention relates to a solution sending apparatus which mixes and sends out at least two solutions, for example, to a mobile-phase gradient solution sending apparatus in liquid chromatography.

2. Description of the Related Art

The solution sending apparatus for micro high-performance liquid chromatography (micro HPLC) and nano high-performance liquid chromatography (nano HPLC) includes a direct type solution sending apparatus and a split type solution sending apparatus. The solution of the mobile phase having a micro flow rate is sucked and sent in the direct type solution sending apparatus. In the split type solution sending apparatus, the solution of the mobile phase having the flow rate ranging from 10 to 1000 μL/min is sucked and split with a split mechanism, and the solution sending is performed only to the mobile phase having the necessary flow rate. For the high-pressure gradient solution sending apparatus for the micro HPLC and the nano HPLC, there are also a direct type solution sending apparatus and a split type solution sending apparatus.

FIG. 5 is a block diagram showing a flow channel of the conventional direct type high-pressure gradient solution sending apparatus. Solution sending pumps 2a and 2b are provided on solution sending flow channels 13a and 13b through which the solutions of mobile phases “A” and “B” put in bottles 1a and 1b are sent respectively. In the solution sending pumps 2a and 2b, a solution sending amount is adjusted by controlling the number of revolutions of a motor. The solution sending flow channels 13a and 13b flow into each other at a mixer 5, and the mixer 5 mixes the mobile phases “A” and “B” and sends the mixed solution to an analysis flow channel 14. In the analysis flow channel 14, a separation column 7 is provided on the downstream side of a sample injection unit (injector) 6, and a detector 8 is provided on the downstream side of the separation column 7. The sample injected from the sample injection unit 6 is introduced to the separation column 7 by the mobile phase mixed in the mixer 5, the sample is separated in each component, and the separated sample component is detected by a detector 8. The gradient type in which the plurality of mobile phases are caused to flow into each other on the downstream side of the solution sending pump using the plurality of solution sending pumps is called high-pressure gradient type (for example, see Japanese Patent Laid-Open No. 2003-98166).

The direct type high-pressure gradient solution sending apparatus is a general one in which a plurality of direct type solution sending pumps are simply combined, and the excessive mobile phase is not required. Therefore, there is an advantage that an amount of consumption is small in the mobile phase. At the same time, a slight fluctuation in solution sending operation has a large influence on the flow rate, so that sometimes pulsation or uneven solution sending is generated.

On the other hand, the split type gradient solution sending apparatus includes a high-pressure gradient type apparatus (FIG. 6) which further includes a split mechanism (splitter) 3 on the downstream side of the mixer 5 having a flow channel configuration of FIG. 5. The split type gradient solution sending apparatus also includes a low-pressure gradient type apparatus (FIG. 7) in which the solution sending pump having a flow channel configuration of FIG. 6 is commonly used through a valve 15.

In these split type gradient solution sending apparatuses, there is the advantage of small pulsation and high mixed concentration accuracy. At the same time, because the flow is split by the split mechanism 3 after the mobile phases are mixed by the mixer 5, the mobile phase discharged from the split mechanism 3 becomes the mixed solution. Therefore, the mixed solution cannot be reused, and the mobile phase is uselessly consumed.

In the gradient solution sending, a ratio of the mixed concentration is successively changed, so that viscosity of the mixed solution is also successively changed. Because a split ratio of the split mechanism is set by a resistance tube or an orifice valve, the split ratio is also changed when the viscosity is changed. Therefore, the correct flow rate cannot be secured. Even if a flow meter 4 measuring a solution sending flow rate is provided on the downstream side of the split mechanism, the flow rate cannot correctly be measured when the viscosity and specific heat of the mixed solution are successively changed by the gradient because the flow meter measures the flow rate from the viscosity or thermal conductivity of the liquid.

### SUMMARY OF THE INVENTION

In view of the foregoing, an object of the invention is to provide a gradient solution sending apparatus, in which the waste of mixing the mobile phase and discharging it from the split mechanism is eliminated, the pulsation is decreased, and the mixed concentration accuracy is high.

A gradient solution sending apparatus according to the invention, as shown in FIG. 1 showing one embodiment, includes a plurality of solution sending flow channels 13a and 13b,a mixer 5 to combine these solution sending flow channels 13a and 13b and mix mobile phases sent through the solution sending flow channels 13a and 13b, a gradient controller 11 in which a solution sending flow rate of the mobile phase is set in each solution sending flow channel 13a and 13b, and a control device 10a and 10b which controls a respective solution sending flow rate of the mobile phase in each solution sending flow channel 13a, 13b, based on the solution sending flow rate set in the gradient controller 11. The solution sending flow channels 13a and 13b include a solution sending pump 2a, 2b sending mobile phase “A”, “B”, and a splitter 3a, 3b as the split mechanism. The splitter 3a, 3b delivers a part of the mobile phase passing through the solution sending pump 2a and 2b to the mixer 5, and discharges the rest of the mobile phase “A” and “B” from the solution sending flow channel 15a, 15b;

In FIG. 1, splitters 3a and 3b, ratios Xa/Ya and Xb/Yb of flow rates Xa and Xb sent to a mixer 5 through the solution sending flow channels 13a and 13b and flow rates Ya and Yb of the mobile phases passing through solution sending pumps 2a and 2b is called split ratios of the splitters 3a and 3b respectively.

According to the invention, the split mechanism is provided in each of the plurality of solution sending flow channels, and the mobile phase is split before mixed with the mixer. Therefore, the mobile phase which is split and discharged by the split mechanism can be reused by reserving the mobile phase or by returning the mobile phase to the mobile phase container, and the useless consumption of the mobile phase can be suppressed. As a result, the stable gradient solution sending can be performed with the little pulsation and uneven solution sending which are of the features of the split type solution sending apparatus.

In the conventional case where the split mechanism is arranged in the subsequent stage of the mixer, a capacity from the mixer to the sample injection unit, i.e., so-called “delay capacity” is increased. On the contrary, in the invention, because the split mechanism is arranged in a forestage of the mixer, the “delay capacity” is decreased and the gradient delay time can be shortened.

Furthermore, because the mobile phases pass through the split mechanism before the mobile phases are mixed together, the correct split ratio is always maintained independently of the gradient concentration, which allows the solution sending to be correctly performed.

The invention is suitable to the solution sending apparatus in which at least two liquids are mixed and sends at a micro flow rate, for example, the mobile-phase micro gradient solution sending apparatus for the liquid chromatography.

As shown in FIG. 1, in the case where the plurality of solution sending flow channels 13a and 13b including the solution sending pumps and the splitters are simply combined, pressure of several megapascals to 20 megapascals is applied to the column 7 in addition to the flow from the splitter 3a toward the column 7 through the mixer and the sample injection unit 6. Therefore, sometimes an interference flow is generated from the splitter 3a toward the discharge side of the other splitter 3b through the mixer 5. When the interference flow is generated, in order to negate the interference flow, the other solution sending pump 2b sends the solution to push back the interference flow. As a result, solution sending pumps 2a and 2b and the splitters 3a and 3b interfere mutually with each other, and sometimes the stable solution sending is hardly performed.

Therefore, in order to suppress the interference flow, preferably each solution sending flow channel 13a, 13b includes a flow channel resistor in a subsequent stage of the splitter 3a, 3b. A resistance tube and a needle valve can be used as the flow channel resistor. In the resistance tube, the flow channel resistance is increased by decreasing a flow channel diameter or by lengthening the flow channel. The needle valve becomes a variable flow channel resistor.

In each solution sending flow channel, when the flow channel resistor is provided in the subsequent stage of the split mechanism to the mixer, the mutual interference generated between the solution sending pumps can be suppressed. When the flow channel resistor is used as the resistance tube, the flow channel resistance can stably be obtained with a simple configuration.

In the case where the solution sending flow channel includes the flow channel resistor in the subsequent stage of the splitter 3a, 3b, or in the case where the solution sending flow channel does not include the flow channel resistor, preferably each solution sending flow channel includes flow meters 4a, 4b measuring the solution sending flow rate in the subsequent stage of the split mechanism. Because the mobile phases passing through the flow meters 4a, 4b are in the pre-mixing state, the flow rate is correctly measured irrespective of the mixed concentration change caused by the gradient, and the correct flow rate can be secured.

In the case where the flow meters 4a, 4b are provided, preferably the control device 10a, 10b controls the solution sending flow rate of the solution sending pump based on a value measured by the flow meter so that the measured value is brought close to a previously set value, or preferably the control device controls a split ratio of the split mechanism based on a value measured by the flow meter so that the measured value is brought close to a previously set value. The feedback control can correctly be performed based on the correct measured value of the flow rate, when the feedback control is performed to the solution sending flow rate of the solution sending pump or the split ratio set value of the split mechanism based on the value measured by the flow meter.

Before the analysis is started, assuming that a solution of a mobile phase “A” is 100% and a solution of a mobile phase “B” is 0%, water-tightness of the solution sending pump which is in the stopped state is not completely maintained, when the mobile phases “A” and “B” are maintained in the pre-analysis state. Therefore, there is generated a back flow phenomenon that the mobile phase “A” which is located on the solution sending side is pushed out to the solution sending pump 2b. When the amount of back flow is increased, the solution of the mobile phase “B” corresponding to the amount of back flow is not sent even if the solution sending apparatus starts the solution sending after the analysis is started, and the gradient rise becomes worsened, which results in the problem that the analysis cannot correctly be performed. Therefore, in a more preferred embodiment of the invention, in order to prevent the back flow, preferably the flow meter is able to detect a back flow, and the control device drives the solution sending pump to negate the back flow when the flow meter detects the back flow in the solution sending flow channel whose set flow rate is zero. Thus, the back flow of the mobile phase can be prevented even in the solution sending flow channel in which the solution sending is stopped, and thereby the gradient rise is improved.

Furthermore, each solution sending flow channel may include a check valve preventing the back flow in the subsequent stage of the split mechanism. In this case, the back flow of the mobile phase can further effectively be prevented to suppress the mutual interference generated between the solution sending pumps.

Thus, when the flow channel components such as the flow channel resistor, the flow meter, and the check valve are used in the gradient solution sending apparatus, the stable and even gradient solution sending can be realized with the little pulsation.

In the mode in which the mobile phase is reused, preferably a flow channel returning the discharged mobile phase to each mobile phase container is connected to a discharge side of the split mechanism of each solution sending flow channel. Therefore, the mobile phase is easily recovered and reused.

### BRIEF DESCRIPTION OF THE DRAWINGS

FIG. 1 is a block diagram showing a flow channel according to a first embodiment of the invention;

FIG. 2 is a block diagram a feedback control system in a solution sending unit of the first embodiment;

FIG. 3 is a block diagram showing a flow channel according to a second embodiment of the invention;

FIG. 4 is a graph showing solution sending result of the second embodiment;

FIG. 5 is a block diagram showing a flow channel of a conventional direct type high-pressure gradient solution sending apparatus;

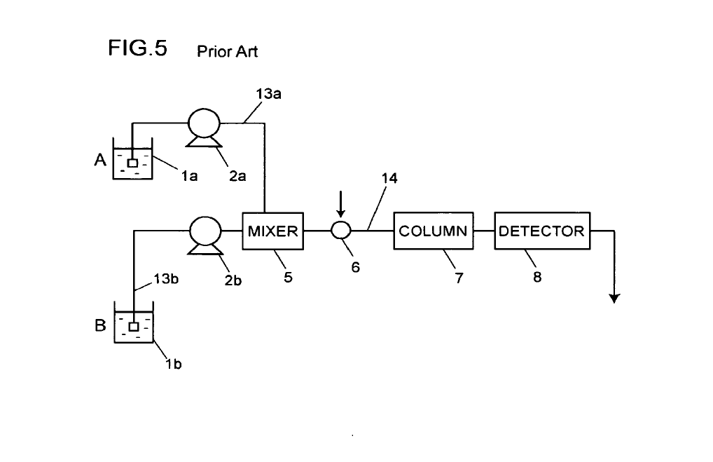

FIG. 6 is a block diagram showing of a flow channel of a conventional split type high-pressure gradient solution sending apparatus; and

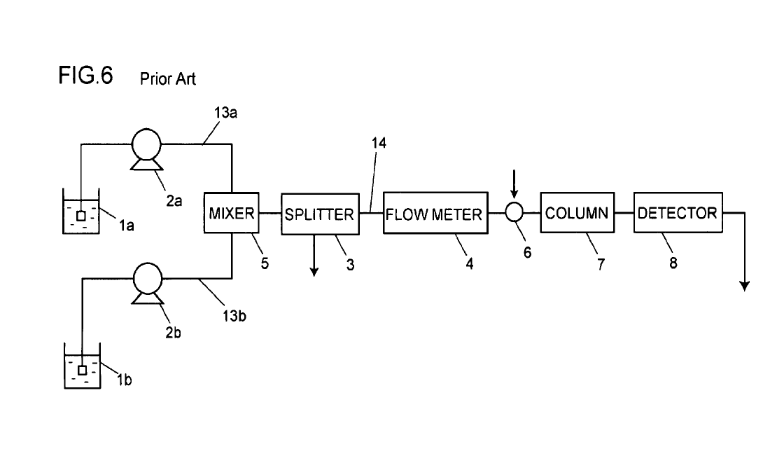

FIG. 7 is a block diagram showing a flow channel of a conventional split type low-pressure gradient solution sending apparatus.

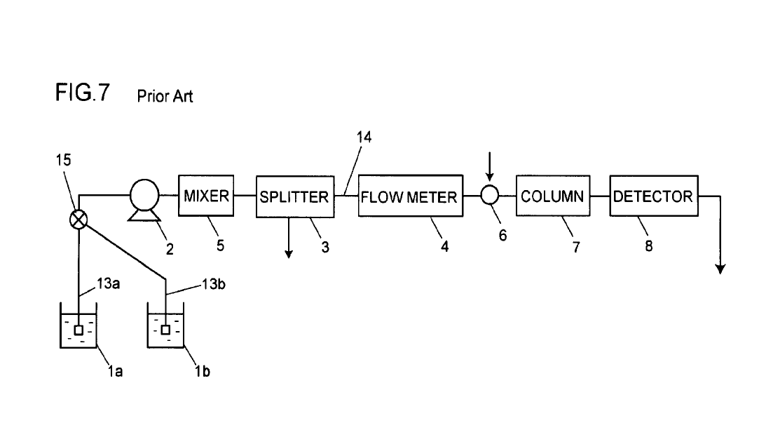

### DESCRIPTION OF THE PREFERRED EMBODIMENT

A preferred embodiment of the invention will be described in detail with reference to the drawings.

### First Embodiment

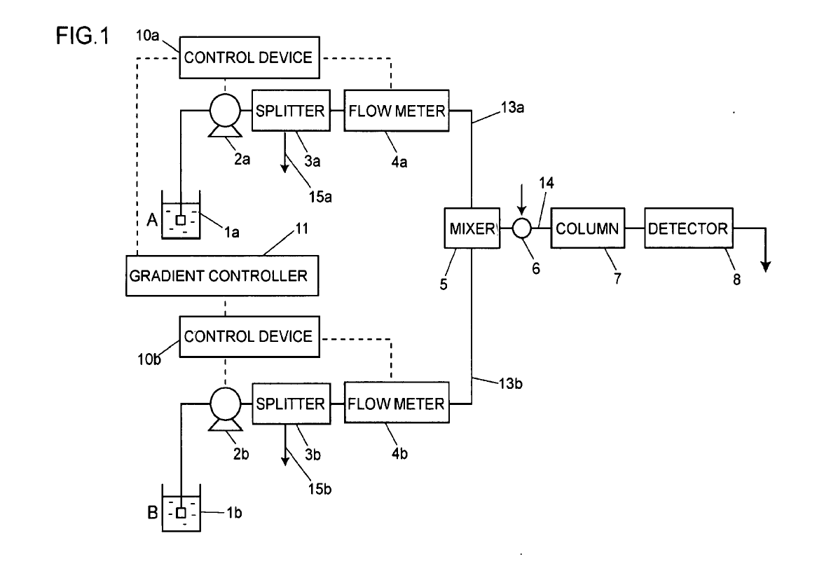

FIG. 1 is a block diagram showing a flow channel according to a first embodiment of the invention. Solution sending flow channels 13a and 13b send solutions of mobile phases “A” and “B” put in solvent bottles 1a and 1b which are of a mobile phase container. Solution sending pumps 2a and 2b are provided in the solution sending flow channels 13a and 13b, and the solution sending pumps 2a and 2b send the solution of the mobile phases “A” and “B” respectively. Control devices 10a and 10b are connected to the solution sending pumps 2a and 2b, and the control devices 10a and 10b control solution sending mechanisms in the solution sending pumps 2a and 2b according to set flow rates respectively.

The control devices 10a and 10b are connected to a gradient controller 11, and the gradient controller 11 transmits the set flow rates to the control devices 10a and 10b based on a set gradient program.

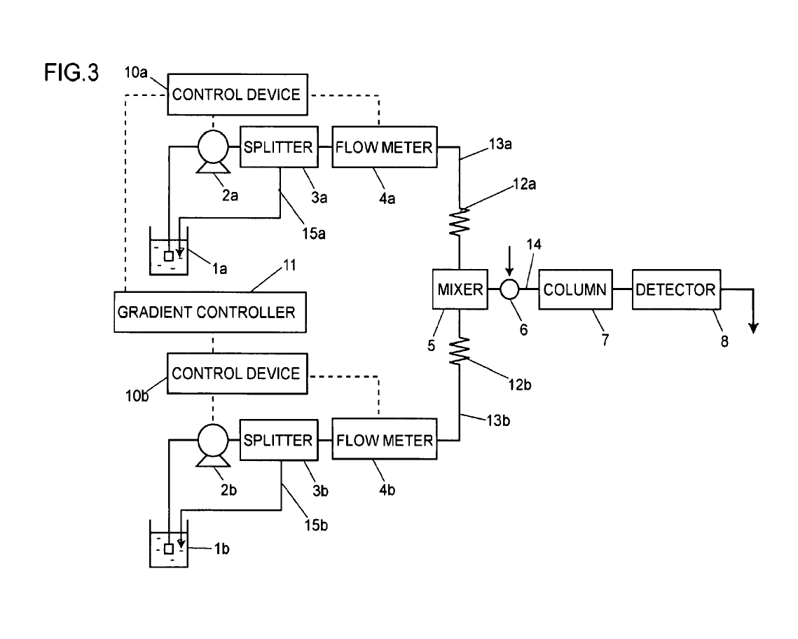

A splitter 3a as a split mechanism for the mobile phase “A” is provided on a discharge side of the solution sending pump 2a, and a splitter 3b as another split mechanism for the mobile phase “B” is provided on a discharge side of the solution sending pump 2b. The splitters 3a and 3b split the mobile phases sent from the solution sending pumps 2a and 2b to a side of an analysis flow channel 14 and sides of discharge flow channels 15a and 15b respectively. The discharge flow channels 15a and 15b may be connected to the solvent bottles 1a and 1b so that the solvents are returned to the solvent bottles 1a and 1b like a second embodiment shown in FIG. 3. The discharge flow channels 15a and 15b may also be connected to the containers for reserving the solvents so that the solvents are reserved in the containers. In both cases, the solvents from the discharge flow channels 15a and 15b can be reused because the solvents are not mixed together.

Each of the solution sending pumps 2a and 2b can stably send the solution with high accuracy at a flow rate ranging from about 1 to about 1000 μL/min. The solution sending pumps 2a and 2b send the solvents while split ratios Xa/Ya and Xb/Yb of the solution sending pumps 2a and 2b are set to about 1/10 to 1/10000 with the splitters 3a and 3b. The solution sending pumps 2a and 2b can stably send the solvents to the analysis flow channel 14 at an ultra-micro flow rate ranging from 1 to 5000 nL/min.

The solution sending flow channels 13a and 13b flow into each other at a mixer 5, and the mixer 5 mixes the mobile phases “A” and “B” to send the solution to the analysis flow channel 14. A separation column 7 is provided in the analysis flow channel 14 on the downstream side of a sample injection unit (injector) 6, and a detector 8 is provided on the downstream side of the column 7.

In the splitters 3a and 3b, the mobile phases cannot be split stably, when viscosity of the sent mobile phase is changed depending on an ambient temperature or a kind of the solvent used, or when an orifice valve or a resistance tube on the discharge side or the column on the analysis flow channel side is clogged up. Therefore, in the solution sending flow channels 13a and 13b, flow meters 4a and 4b are provided in subsequent stages (analysis flow channel side) of the splitters 3a and 3b. Any method such as a method of heating a central portion of the flow channel with a heater to measure a temperature gradient between the upstream side and the downstream side or a method of incorporating a small water wheel into the flow channel to measure revolving speed of the water wheel can be adopted in the flow meters 4a and 4b.

The flow rates measured by the flow meters 4a and 4b are transmitted to the control devices 10a and 10b respectively. The control devices 10a and 10b perform feedback control to the solution sending mechanisms of the solution sending pumps 2a and 2b so that the flow rates measured by the flow meters 4a and 4b are brought close to set flow rates transmitted from the gradient controller 11, which enables the solution sending to be accurately performed at a micro flow rate.

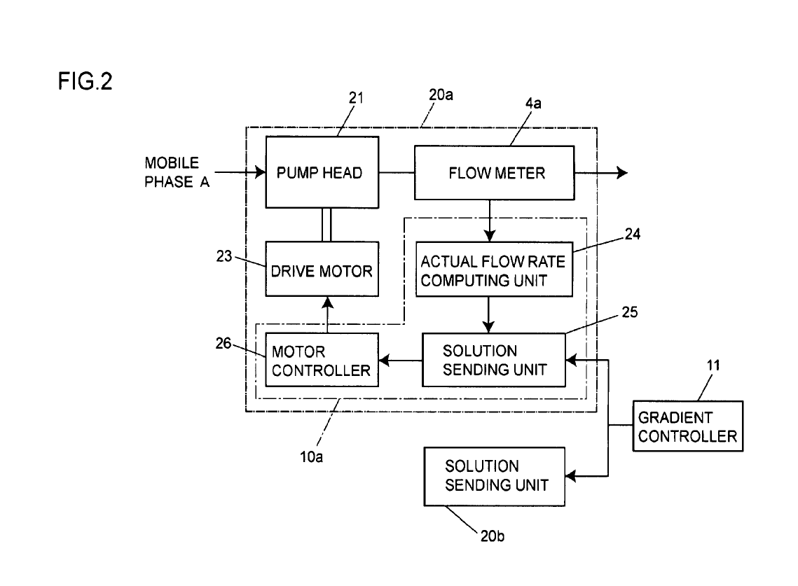

FIG. 2 shows a feedback control system in the solution sending mechanism of the solution sending pumps 2a and 2b. A solution sending unit 20a includes the solution sending pump 2a, the flow meter 4a, and the control device 10a. A solution sending unit 20b includes the solution sending pump 2b, the flow meter 4b, and the control device 10b. Because the solution sending units 20a and 20b have the same configuration, only the solution sending unit 20a will be described in detail while the solution sending unit 20b is shown as one block.

The solution sending pump 2a includes a solution sending pump head 21 and a drive motor 23 which drives the solution sending pump head 21. The flow meter 4a is provided on the side of the analysis flow channel 14 from the solution sending pump head 21.

The control device 10a includes an actual flow rate computing unit 24, a solution sending control unit 25, and a motor control unit 26. The control device 10b arranged in the solution sending unit 20b has the same configuration. The actual flow rate computing unit 24 takes in a signal from the flow meter 4a and computes the flow rate. The solution sending control unit 25 causes the motor control unit 26 to control the revolving speed of the drive motor 23 of the solution sending pump 2a based on the set value of the gradient controller 11 and the flow rate value computed by the actual flow rate computing unit 24. The motor control unit 26 controls the revolution of the drive motor 23, which allows the solution of the mobile phase to be sent at a predetermined flow rate by the solution sending pump head 21.

The solution sending control unit 25 takes in the set value in the gradient controller 11. When the set flow rate is not zero, the solution sending control unit 25 rotates the drive motor 23 through the motor control unit 26 at the revolving speed corresponding to the set value, and the solution sending control unit 25 adjusts the revolving speed of the drive motor 23 so that the flow rate measured value from the actual flow rate computing unit 24 becomes the set value. Thus, the solution of the mobile phase “A” is sent at the set flow rate through the solution sending flow channel 13a.

The feedback control is similarly performed to the solution sending of the mobile phase “B” through the solution sending flow channel 13b.

The control devices 10a and 10b and the gradient controller 11 are formed by CPU (Central Processing Unit) or the like. In the first embodiment, the control units are connected to the solution sending flow channels 13a and 13b respectively. Alternatively, the control devices 10a and 10b may be united into one device, the control devices 10a and 10b and the gradient controller 11 may be realized by one CPU, and functions for the solution sending flow channels 13a and 13b may be realized by programs respectively.

The feedback control in gradient rise of the solution sending unit in the first embodiment will be described with reference to FIG. 1. In the gradient rise of the high-pressure gradient solution sending, the mixture ratio becomes 100:0 or 0:100 in the two solutions of the mobile phases. Even in this case, preferably solution sending operation is not stopped in the solution sending pump on the side of which the mobile phase becomes 0%. For example, assuming that the “A” solution is set to 100% and the “B” solution is set to 0%, when the solution sending operation is completely stopped in the solution sending pump 2b, the solution sending pump 2a is connected not only onto the side of the analysis flow channel 14 from the mixer 5 to the separation column 7 through the sample injection unit 6 but also onto the discharge flow channel side of the splitter 3b from the mixer 5 through the flow meter 4b of the “B” solution flow channel. Therefore, the “A” solution which should originally be sent to the separation column 7 is split at the mixer 5 on the same principle as the splitter.

Generally the check valves are provided on the suction side and the discharge side of the solution sending pump. In this case, a risk of the back flow into the solution sending pump 2b is small. However, when the solution sending amount becomes a level of nL (nanoliter) per minute, the risk of the back flow cannot be neglected. In order to prevent the back flow, preferably the solution sending pump 2b continues the solution sending so that the flow rate measured by the flow meter 4b becomes zero.

The operation in the gradient rise is specifically performed as follows. When the gradient controller 11 sets the flow rate of the solution sending flow channel 13a to zero, the flow meter 4a confirms whether or not the actual flow rate becomes zero. It is assumed that the flow meter 4a can detect the back flow. In the mechanism in which the flow meter 4a measures the temperature gradient generated by heating with a heater, when the temperature gradient becomes opposite that of the normal solution sending, the flow meter 4a can estimate the back flow. The flow meter 4a which has the mechanism of the micro water wheel can estimate the back flow when the water wheel is revolved in the opposite direction from the normal solution sending. When the actual flow rate computing unit 24 judges that the back flow is generated, the actual flow rate computing unit 24 informs the back flow generation to the solution sending control unit 25. The solution sending control unit 25 imparts the number of revolutions of the motor overcoming the back flow amount to the drive motor 23. While the actual flow rate is measured, the number of revolutions of the motor is adjusted so that the actual flow rate becomes zero, and the number of revolutions of the motor is maintained in the state in which the actual flow rate becomes zero. This method shall be called “method of maintaining zero flow rate in feedback control.”

Similarly, in the other solution sending unit 20b, the number of revolutions of the drive motor (not shown) of the solution sending pump 2b is controlled to prevent the back flow in the set flow rate of zero. Thus, the state in which neither the back flow nor the solution sending is performed can be made by the feedback control, because the flow rate control mechanism is operated in the closed loop.

### Second Embodiment

In operating the gradient solution sending apparatus of the first embodiment shown in FIG. 1, sometimes the mutual interference becomes a problem between the solution sending pumps. That is, the solutions of the mobile phases sent by the two solution sending pumps 2a and 2b interfere with each other through the splitters 3a and 3b.

FIG. 3 is a block diagram showing a flow channel according to a second embodiment in which improvement is made to suppress the mutual interference. Resistance tubes 12a and 12b are provided as the flow channel resistor between the mixer 5 and the flow meters 4a and 4b of the solution sending flow channels 13a and 13b respectively. The mobile phases split by the splitters 3a and 3b are split by a resistance ratio of the side of the analysis flow channel 14 and the side of the discharge flow channels 15a and 15b respectively. In this case, the discharge flow channels 15a and 15b of the splitters 3a and 3b are connected to the solvent bottles 1a and 1b and the discharged solvents are returned to the solvent bottles 1a and 1b respectively.

In the second embodiment, the resistance tubes 12a and 12b are respectively arranged between the mixer 5 and the flow meters 4a and 4b of the solution sending flow channels 13a and 13b in order to decrease the mutual interference between the solution sending pumps 2a and 2b. Desirably the pressure ranging from about 1 to about 5 MPa is applied in the flow rate range where the resistance tubes 12a and 12b are used.

In the second embodiment, the discharge flow channels 15a and 15b of the splitters 3a and 3b are connected to the solvent bottles 1a and 1b, and the pre-mixing solvents split by the splitters 3a and 3b are returned to the solvent bottles 1a and 1b. In the splitters 3a and 3b, the flow rate of the discharged solution is much larger than the flow rate of the solution which is sent as the mobile phase onto the side of the analysis flow channel 14. Therefore, the large consumption amount in the mobile phase, which is of the largest drawback of the split type gradient solution sending system, can be overcome by the simple flow channel configuration.

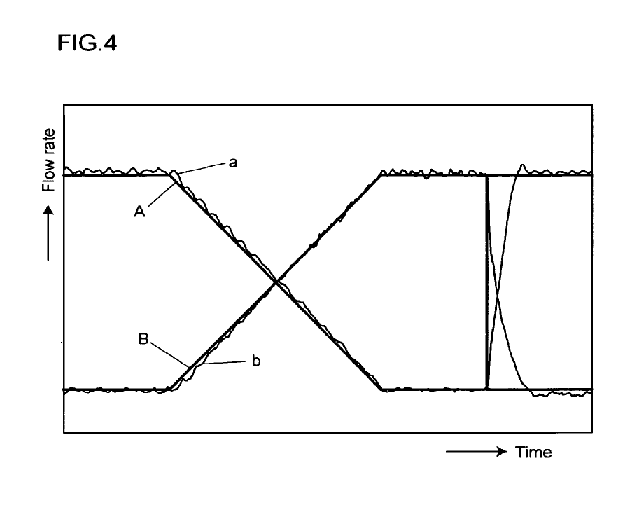

FIG. 4 shows the solution sending result of the second embodiment A vertical axis indicates the flow rate and a horizontal axis indicates the time. The solution sending result of FIG. 4 is obtained under the following conditions.

(1) Kinds of the solvents in the solvent bottles 1a and 1b:

Although an organic solvent such as acetonitrile is used as one of the solvents in the solvent bottles 1a and 1b in the actual analysis, the water is used in the measurement for obtaining the data. Equal performance is obtained irrespective of the kind of the mobile phase.

(2) Kinds of the separation column 7, adaptable flow rate range, and the like:

The measurement for obtaining the data is a test measurement for checking the gradient performance, so that the measurement is performed while the column and detector necessary for the analysis are not connected. The resistance tube is used in place of the separation column 7. The adaptable flow rate ranges from 100 nL to 5000 nL (applied pressure ranges from 1 to 20 MPa). The condition can be applied to the wide column condition.

(3) Sizes of resistance tubes 12a and 12b (material and inner diameter×length):

A fused quartz capillary having an inner diameter of 25 μm, an outer diameter of 370 μm, and a length of 1 m is used as the resistance tubes 12a and 12b. There are also resistances in the discharge flow channels 15a and 15b of the splitters 3a and 3b. A PEEK (poly ether etherketone) resin tube having an inner diameter of 65 μm, an outer diameter of 1.6 mm, and a length of 2 m is used as the discharge flow channels 15a and 15b.

In FIG. 4, a straight line designated by the letter “A” indicates the set flow rate of the solution sending flow channel 13a, a straight line designated by the letter “B” indicates the set flow rate of the solution sending flow channel 13b, and the set flow rates of the solution sending flow channels 13a and 13b are the post-split flow rate performed by the splitters 3a and 3b. A curved line designated by the letter “a” is the flow rate measured by the flow meter 4a of the solution sending flow channel 13a. A curved line designated by the letter “b” is the flow rate measured by the flow meter 4b of the solution sending flow channel 13b. The measured flow rates of the solution sending flow channels 13a and 13b are the flow rates in which the feedback control is performed to the solution sending pumps 2a and 2b so that the measured flow rates are brought close to the set flow rates respectively. As can be seen from the result of FIG. 4, the measured flow rates “a” and “b” well follow the set flow rates “A” and “B”. Therefore, the feedback control is correctly performed by inserting the resistance tubes 12a and 12b.

In the second embodiment, after solutions having the flow rates measured by the flow meters 4a and 4b are sent to the control devices 10a and 10b respectively, the feedback control is performed to the solution sending mechanisms of the solution sending pumps 2a and 2b. Alternatively, the predetermined flow rate may be obtained by performing the feedback control to the split ratio of the splitters 3a and 3b while the solution sending pumps 2a and 2b continue the solution sending at constant flow rates. In this case, for example, an electromagnetic type orifice valve is used as the discharge flow channel resistors of the splitters 3a and 3b, and the feedback control is performed to the opening and closing of the orifice valve.

The check valves which prevent the back flow of the mobile phases may be provided in the flow channels between the mixer 5 and delivery sides of the splitters 3a and 3b as the mechanism which prevents the back flow in the case where the mixed ratio of the two liquids of the mobile phases “A” and “B” becomes 100:0 or 0:100. In the second embodiment of FIG. 3, the position at which the check valve is arranged may be located between the mixer 5 and the resistance tubes 12a and 12b, or the position may be located between the splitters 3a and 3b and the resistance tubes 12a and 12b.

When the check valve is provided, in addition to the “method of maintaining zero flow rate in feedback control,” the advantage of preventing the back flow phenomenon can be obtained. In the “method of maintaining zero flow rate in feedback control,” because the solution sending pumps 2a and 2b are pre-pressurized even if the flow rate becomes zero, there is the advantage of decreasing the rise delay of the gradient solution sending. Furthermore, the “method of maintaining zero flow rate in feedback control” also has the advantage of preventing the micro leakage of the check valve in each of the solution sending pumps 2a and 2b and the check valve which may be provided in the subsequent stage of the splitter. Therefore, the “method of maintaining zero flow rate in feedback control” is the more effective method in the invention.

In the second embodiment, the single resistance tube is used as the flow channel resistor for preventing the mutual interference. Alternatively, a plurality of resistance valves are connected in parallel, the plurality of resistance valves are selected by a flow channel switching valve, and the flow channel resistance may be adjusted by switching the resistance valves with the flow channel switching valve. A needle valve which becomes a variable flow channel resistor may be used as the flow channel resistor, and the flow channel resistance may be adjusted by adjustment of a needle position. In the case of the use of the flow channel resistor whose flow channel resistance is variable, the flow channel resistor is switched to the low resistance when the solution sending is performed at a high flow rate, and the flow channel resistor is switched to the high resistance when the solution sending is performed at a low flow rate. Therefore, the stable solution sending can be achieved in the wide flow rate range.

Although the two-liquid high-pressure gradient solution sending apparatus is shown in the invention, a three-liquid or more high-pressure gradient solution sending apparatus can be realized in the same manner.

1. (canceled)

2. A gradient solution sending apparatus comprising
a plurality of solution sending flow channels in which each solution sending flow channel includes a solution sending pump and a split mechanism, the solution sending pump sending a solution of a mobile phase, the split mechanism delivering a part of the mobile phase passing through the solution sending pump to a downstream side and discharging the rest of the mobile phase from the solution sending flow channel;
a mixer which is arranged on the downstream sides of the solution sending flow channels to mix the mobile phases sent through the solution sending flow channels;
a gradient controller in which a solution sending flow rate of the mobile phase is set in each solution sending flow channel; and
a control device which controls the solution sending flow rate of the mobile phase in each solution sending flow channel based on the set flow rate of the gradient controller, wherein each solution sending flow channel includes a flow channel resistor in a subsequent stage of the split mechanism.

3. A gradient solution sending apparatus according to claim 2, wherein each solution sending flow channel includes a flow meter between the split mechanism and the flow channel resistor, the flow meter measuring the solution sending flow rate.

4. A gradient solution sending apparatus according to claim 3, wherein the control device controls the solution sending flow rate of the solution sending pump based on a value measured by the flow meter so that the measured value is brought close to a preset value.

5. A gradient solution sending apparatus according to claim 4, wherein a flow channel is connected to a discharge side of the split mechanism of each solution sending flow channel, the flow channel returning the discharged mobile phase to each mobile phase container.

6-7. (canceled)

8. A gradient solution sending apparatus according to claim 3, wherein the control device controls a split ratio of the split mechanism based on a value measured by the flow meter so that the measured value is brought close to a previously set value.

9. A gradient solution sending apparatus according to claim 8, wherein a flow channel is connected to a discharge side of the split mechanism of each solution sending flow channel, the flow channel returning the discharged mobile phase to each mobile phase container.

10. A gradient solution sending apparatus according to claim 9, wherein the flow meter is able to detect a back flow, and
the control device drives the solution sending pump to negate the back flow when the flow meter detects the back flow in the solution sending flow channel whose set flow rate is zero.

11. A gradient solution sending apparatus according to claim 10, wherein each solution sending flow channel includes a check valve in the subsequent stage of the split mechanism, the check valve preventing the back flow.

12-20. (canceled)
